(19) United States
(12) Patent Application Publication
(10) Pub. No.: US 2026/0302946 A1
(43) Pub. Date: Oct. 1, 2026

(54) Switching Power Converter Circuit and Control Method Thereof

(71) Applicant: PowerX Semiconductor Corporation, Hsinchu County (TW)

(72) Inventors: Tsung-Wei Huang, Hsinchu County (TW); Chieh-Ju Tsai, Hsinchu County (TW); Shao-Chi Huang, Hsinchu County (TW); Ching-Jen Chen, Hsinchu Country (TW)

(73) Assignee: PowerX Semiconductor Corporation, Hsinchu County (TW)

(21) Appl. No.: 19/228,782

(22) Filed: Jun. 5, 2025

(30) Foreign Application Priority Data
Mar. 28, 2025 (TW) 114112005

(51) Int. Cl. H02M 3/158; H02M 1/00; H02M 3/157; H03K 4/06

(52) U.S. Cl. CPC H02M 3/158; H02M 1/0022; H02M 3/157; H03K 4/06

(57) ABSTRACT

A switching power converter circuit includes a power stage circuit, configured to generate an output voltage based on an input voltage; a control circuit, configured to compare a ramp signal with a first reference voltage to generate a control signal for controlling the power stage circuit; and a ramp signal generator, coupled to the control circuit, configured to generate the ramp signal and determine a slope of the ramp signal according to a function; wherein the function includes a plurality of parameters, and the plurality of parameters include the input voltage and a second reference voltage but do not include the output voltage.

### BACKGROUND OF THE INVENTION

### 1. Field of the Invention

The present invention relates to a switching power converter circuit and a control method thereof, and more particularly, to a switching power converter circuit and a control method thereof capable of enhancing system stability and optimizing load transient response performance.

### 2. Description of the Prior Art

Switching power converters are widely used in various electronic devices to convert an input voltage into a desired output voltage. Among numerous control architectures, Constant On-Time (COT) control has gained attention due to its simple structure and fast transient response.

Specifically, a switching power converter with a COT control architecture directly compares the output voltage with a reference voltage to generate a control signal, which has the advantage of extremely fast load transient response performance, as changes in the output voltage can be directly and rapidly reflected in the control signal. However, the COT control architecture lacks an appropriate frequency compensation mechanism, resulting in poor closed-loop stability and affecting the accuracy of the output voltage. Such instability may cause the system to oscillate under certain operating conditions, thereby impacting the reliability of the switching power converter. This issue is particularly significant in low-power applications, which typically require the power converter to achieve high efficiency and fast transient response while maintaining stable and accurate output voltage.

Therefore, how to achieve both fast load transient response and good closed-loop stability with accurate output voltage has become one of the objectives pursued in the field.

### SUMMARY OF THE INVENTION

Therefore, the present invention is to provide a switching power converter circuit and a control method thereof, to address the shortcomings of the prior art.

An embodiment of the present invention discloses a switching power converter circuit, which comprises a power stage circuit, configured to generate an output voltage based on an input voltage; a control circuit, configured to compare a ramp signal with a first reference voltage to generate a control signal for controlling the power stage circuit; and a ramp signal generator, coupled to the control circuit, configured to generate the ramp signal and determine a slope of the ramp signal according to a function; wherein the function includes a plurality of parameters, and the plurality of parameters include the input voltage and a second reference voltage but do not include the output voltage.

Another embodiment of the present invention discloses a control method for a switching power converter circuit. The switching power converter circuit is configured to generate an output voltage based on an input voltage. The control method comprises comparing a ramp signal with a first reference voltage to generate a control signal for controlling the switching power converter circuit; and generating the ramp signal according to a function; wherein the function includes a plurality of parameters, and the plurality of parameters include the input voltage and a second reference voltage but do not include the output voltage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a switching power converter circuit according to an embodiment of the present invention.

FIG. 2 is a schematic diagram of a switching power converter circuit according to an embodiment of the present invention.

FIG. 3 is a schematic diagram of a ramp signal, a second reference voltage, and an output voltage according to an embodiment of the present invention.

FIG. 4A is a schematic diagram of a calibration circuit according to an embodiment of the present invention.

FIG. 4B is a schematic diagram illustrating that the calibration circuit of FIG. 4A adjusts a first transconductance parameter to change the output voltage.

FIG. 5A is a schematic diagram of a calibration circuit according to an embodiment of the present invention.

FIG. 5B is a schematic diagram illustrating that the calibration circuit of FIG. 5A adjusts a second transconductance parameter to change the output voltage.

FIG. 6A is a schematic diagram of a calibration circuit according to an embodiment of the present invention.

FIG. 6B is a schematic diagram illustrating that the calibration circuit of FIG. 6A adjusts a second reference voltage to change the output voltage.

FIG. 7 is a schematic diagram of a control process according to an embodiment of the present invention.

FIG. 8 is a schematic diagram of a conventional switching power converter.

### DETAILED DESCRIPTION

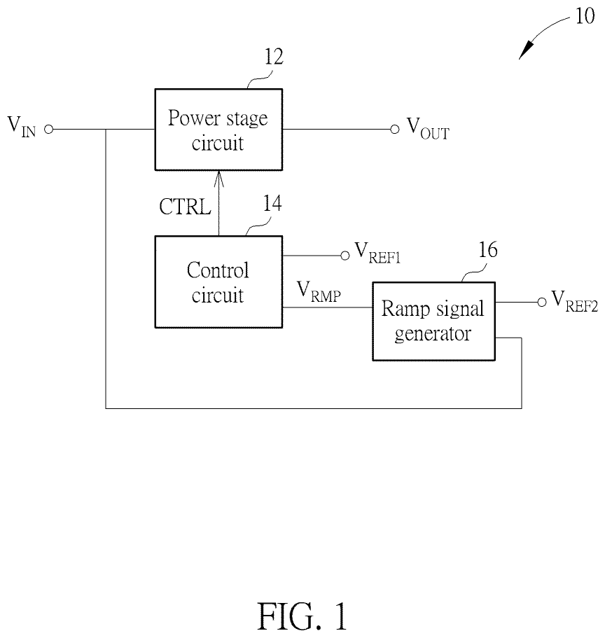

Please refer to FIG. 1, which is a functional block diagram of a switching power converter circuit 10 according to an embodiment of the present invention. The switching power converter circuit 10 includes a power stage circuit 12, a control circuit 14, and a ramp signal generator 16. The power stage circuit 12 is controlled by a control signal CTRL and is configured to generate an output voltage V_{OUT} based on an input voltage V_{IN}. The power stage circuit 12 may be a buck converter, a boost converter, or a buck-boost converter. The control circuit 14 is configured to compare a ramp signal V_{RMP} with a first reference voltage V_{REF1} to generate the control signal CTRL for controlling the power stage circuit 12, wherein the first reference voltage V_{REF1} may be designed to have a temperature-independent fixed voltage value to enhance system stability. The ramp signal generator 16 is coupled to the control circuit 14 and is configured to generate the ramp signal V_{RMP} and determine the slope of the ramp signal V_{RMP} (including both rising and falling slopes) according to a function, wherein the function includes a plurality of parameters, and the parameters include the input voltage V_{IN} and a second reference voltage V_{REF2} but do not include the output voltage V_{OUT}.

In the switching power converter circuit 10, parasitic resistance inevitably exists in the transmission path of the output voltage V_{OUT}, which may cause unstable operation of the control circuit 14, resulting in a significant error between the average value of the output voltage V_{OUT} and its target value. To address this issue, the switching power converter circuit 10 employs the ramp signal generator 16 to generate the ramp signal V_{RMP}, Which enables the control circuit 14 to generate the control signal CTRL based on the ramp signal V_{RMP} and the first reference voltage V_{REF1}. The slope of the ramp signal V_{RMP} generated by the ramp signal generator 16 is determined by a function that includes the input voltage V_{IN} and the second reference voltage V_{REF2} but does not include the output voltage V_{OUT}, and the function may be expressed as f (V_{IN}, V_{REF2}). Since the parameters used by the ramp signal generator 16 to determine the slope of the ramp signal V_{RMP} do not include the output voltage V_{OUT}, noise from the output voltage V_{OUT} is prevented from affecting system performance through the feedback path, thereby ensuring system stability and further improving load transient response performance. Additionally, the switching power converter circuit 10 does not require the use of an error amplifier, which avoids delays caused by resistor-capacitor compensation circuits, achieving faster load transient response. In one embodiment, the switching power converter circuit 10 does not require an error amplifier in circuits related to generating the ramp signal V_{RMP} before the control circuit 14 (e.g., the ramp signal generator 16 or circuits controlling the ramp signal generator 16). In other words, the switching power converter circuit 10 does not need to generate the ramp signal V_{RMP} using an error amplifier.

It should be noted that the ramp signal generator 16 is configured to generate the ramp signal V_{RMP} and determine the slope of the ramp signal V_{RMP} based on the function that does not include the output voltage V_{OUT}. That is, the ramp signal generator 16 does not consider the output voltage V_{OUT} when determining the slope of the ramp p signal V_{RMP}. However, depending on different system requirements or application fields, the output voltage V_{OUT} may still be used in the process of generating the ramp signal V_{RMP} for other purposes, such as serving as a reference potential or initial potential for the ramp signal V_{RMP}. This does not affect the feature of the present invention wherein the slope of the ramp signal V_{RMP} is determined based on the input voltage V_{IN} and the second reference voltage V_{REF2} (rather than the output voltage V_{OUT}). For example, in one embodiment, the switching power converter circuit 10 may further include a calibration circuit coupled to the power stage circuit 12 and the ramp signal generator 16 which is configured to adjust at least one of the parameters of the function, which is used by the ramp signal generator 16 to determine the slope of the ramp signal V_{RMP}, based on the output voltage V_{OUT} and the second reference voltage V_{REF2}, so that the output voltage V_{OUT} approaches a target voltage. In other words, the calibration circuit can provide and adjust the parameters of the function used by the ramp signal generator 16 to ensure the accuracy of the output voltage V_{OUT}.

In short, the slope of the ramp signal VAMP generated by the ramp signal generator 16 is not affected by the output voltage V_{OUT} and noise within the output voltage V_{OUT}, thereby ensuring system stability. Meanwhile, as described above, the switching power converter circuit 10 does not require an error amplifier, so as to avoid delays caused by compensation circuits and achieve faster load transient response.

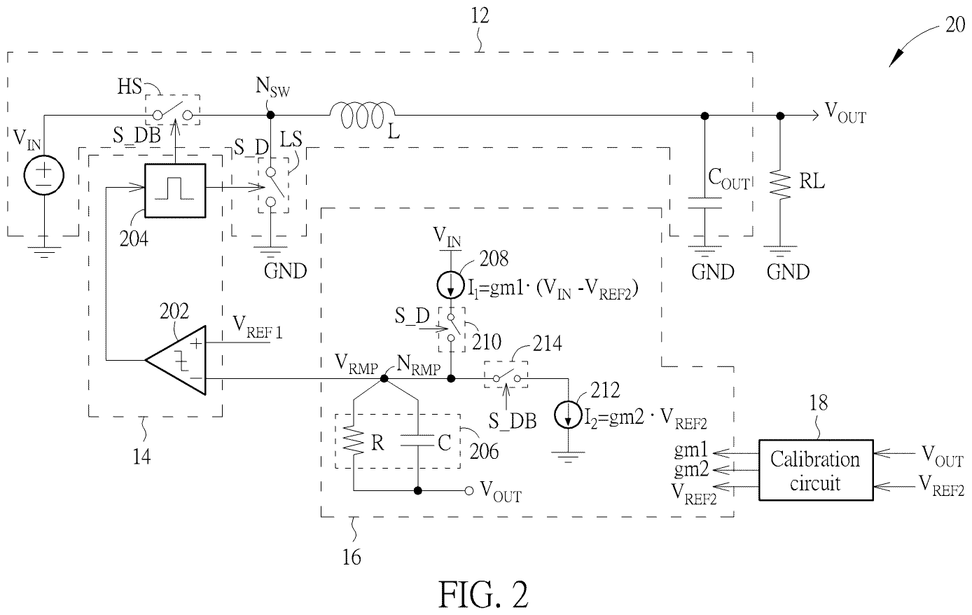

The power stage circuit 12, the control circuit 14, and the ramp signal generator 16 in FIG. 1 represent the basic architecture of the switching power converter circuit 10. Those skilled in the art should appropriately design or adjust the circuit architecture based on system requirements, application fields, etc. For example, please refer to FIG. 2, which is a schematic diagram of a switching power converter circuit 20 according to an embodiment of the present invention. The switching power converter circuit 20 is derived from the switching power converter circuit 10 and may be regarded as an implementation of the switching power converter circuit 10. Therefore, identical symbols are used to represent identical circuits or signals. Specifically, in the switching power converter circuit 20, the power stage circuit 12 includes a high-side switch HS, a low-side switch LS, an inductor L, and an output capacitor Cour. The high-side switch HS is coupled between the input voltage V_{IN} and a switching node N_{SW}, the low-side switch LS is coupled between the switching node N_{SW} and a ground terminal GND, the inductor Lis coupled between the switching node N_{SW} and the output voltage V_{OUT}, and the output capacitor Cour is coupled between the output voltage V_{OUT} and the ground terminal GND. The operating principle of the power stage circuit 12 is well-known in the art. In brief, the high-side switch HS and the low-side switch LS are used to switch the coupling path of the inductor L with either the input voltage V_{IN} or the ground terminal GND, to accumulate or release energy through the inductor L, thereby converting the energy of the inductor L into an appropriate output voltage V_{OUT} and supplying it to a load circuit (e.g., the equivalent resistor RL shown in FIG. 2). Furthermore, in this architecture, it should be ensured that at any given time, only one of the high-side switch HS and the low-side switch LS is conductive to prevent a shoot-through phenomenon caused by simultaneous conduction of both switches, which could lead to a power supply short circuit. Therefore, in FIG. 2, the control signal CTRL is implemented by complementary switching signals S_D and S_DB, meaning that only one switching signal can be in an enabled state at any time. Specifically, the control circuit 14 of the switching power converter circuit 20 is a pulse width modulation (PWM) circuit, which includes a comparator circuit 202 and an on-time generator circuit 204. The comparator circuit 202 receives the first reference voltage V_{REF1} at a positive input terminal (+), receives the ramp signal V_{RMP} at a negative input terminal (−), and compares the ramp signal V_{RMP} with the first reference voltage V_{REF1}. The on-time generator circuit 204 generates the complementary switching signals S_D and S_DB and controls the duty cycle of each of the switching signals S_D and S_DB based on the comparison result of the comparator circuit 202. In other words, if the duty cycle of the switching signal S_D is D, then the duty cycle of the switching signal S_DB is (1-D), and the comparison result of the comparator circuit 202 can adjust the duty cycles D and (1-D) by changing the duration that the switching signal S_D or S_DB is in a disabled state, thereby controlling the off-time of the high-side switch HS and the low-side switch LS, and consequently controlling the energy accumulated by the inductor L to generate an appropriate output voltage V_{OUT}.

In the switching power converter circuit 20, the ramp signal generator 16 includes a resistor-capacitor circuit 206, a first current source 208, a first switch 210, a second current source 212, and a second switch 214. A node NRMP is formed among the negative input terminal of the comparator circuit 202 of the control circuit 14, the resistor-capacitor circuit 206, the first switch 210, and the second switch 214, and the signal at the node NRMP is the ramp signal V_{RMP}. The resistor-capacitor circuit 206 includes a resistor R and a capacitor C connected in parallel, coupled between the comparator circuit 202 of the control circuit 14 and the output voltage V_{OUT} (i.e., between the node NRMP and the output voltage V_{OUT}), which allows the output voltage V_{OUT} to be directly coupled to the ramp signal V_{RMP}, thereby accelerating the response speed to load transients. The first current source 208 is configured to generate a first current I₁, which is related to the input voltage V_{IN}, the second reference voltage V_{REF2}, and a first transconductance parameter gm1, i.e., I₁=gm1·(V_{IN}−V_{REF2}). One terminal of the first switch 210 is coupled to the first current source 208, and the other terminal thereof is coupled to the node NRMP. The first switch 210 is configured to switch the conduction state between the two terminals based on the switching signal S_D. The second current source 212 is configured to generate a second current I₂, which is related to the second reference voltage V_{REF2} and a second transconductance parameter gm2, i.e., I₂=gm2·V_{REF2}. One terminal of the second switch 214 is coupled to the node NRMP, and the other terminal thereof is coupled to the second current source 212. The second switch 214 is configured to switch the conduction state between the two terminals based on the switching signal S_DB.

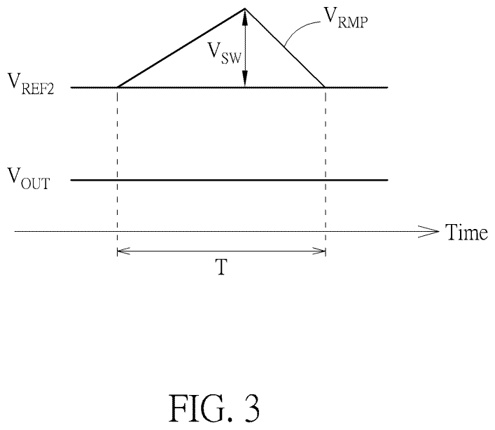

Further, the resistor-capacitor circuit 206 can be regarded as an integrator, which cooperates with the first current source 208 and the second current source 212 to generate the ramp signal V_{RMP}. Specifically, when the switching signal S_D is in an enabled state to turn on the first switch 210 and the switching signal S_DB is in a disabled state to turn off the second switch 214, the first current I₁ from the first current source 208 charges the capacitor C, which causes the resistor-capacitor circuit 206 to generate the rising phase of the ramp signal V_{RMP}. When the switching signal S_D is in a disabled state to turn off the first switch 210 and the switching signal S_DB is in an enabled state to turn on the second switch 214, the second current source 212 draws the second current I₂ from the capacitor C, which causes the resistor-capacitor circuit 206 to generate the falling phase of the ramp signal V_{RMP}. The control circuit 14 compares the ramp signal V_{RMP} with the first reference voltage V_{REF1}, and based on this comparison, controls the duty cycles of the switching signals S_D and S_DB, thereby controlling the amplitude V_{SW} of the ramp signal V_{RMP} (i.e., the difference between the voltage value of the ramp signal V_{RMP} at the transition from the rising phase to the falling phase and the minimum voltage value of the ramp signal V_{RMP}). This amplitude is also related to the switching of the voltage at the node N_{SW} (inductor L), such that the control circuit 14 can regulate the output voltage V_{OUT} to maintain a target voltage. The ramp signal V_{RMP} is superimposed on the output voltage V_{OUT} through the resistor-capacitor circuit 206, and the relative relationship among the ramp signal V_{RMP}, the second reference voltage V_{REF2}, and the output voltage V_{OUT} can be represented as shown in FIG. 3.

Through the above feedback control mechanism, the output voltage V_{OUT} can be maintained at the target voltage. It should be noted that, in the embodiment of FIG. 2, the output voltage V_{OUT} is coupled to the ramp signal V_{RMP} through the resistor-capacitor circuit 206, but the output voltage V_{OUT} only affects the level of the ramp signal V_{RMP} and does not affect the rising or falling slope of the ramp signal V_{RMP}. Therefore, in one embodiment, the ground terminal GND may replace the output voltage V_{OUT} and be connected to the resistor-capacitor circuit 206 (i.e., the resistor-capacitor circuit 206 is coupled between the node NRMP and the ground terminal GND). In this case, the signal from the ground terminal GND is coupled to the ramp signal V_{RMP} through the resistor-capacitor circuit 206. Alternatively, in another embodiment, the resistor-capacitor circuit 206 may further include a switching switch configured to switch the connection to either the output voltage V_{OUT} or the ground terminal GND, to allow selective coupling of the signal from either the output voltage V_{OUT} or the ground terminal GND to the ramp signal V_{RMP}. It should be noted that when the output voltage V_{OUT} is coupled to the ramp signal V_{RMP}, the load transient response performance is better, whereas when the signal from the ground terminal GND is coupled to the ramp signal V_{RMP}, the load transient response performance is poorer but still functional, depending on the designer's choice.

In short, in the embodiment of FIG. 2, the slope of the ramp signal V_{RMP} is primarily influenced by the input voltage V_{IN} and the second reference voltage V_{REF2}. Additionally, in this embodiment, the first transconductance parameter gm1 and the second transconductance parameter gm2 can also be used to adjust the slope of the ramp signal V_{RMP}.

Based on the above, the rising slope of the ramp signal V_{RMP} is determined by the first current I₁ (I₁=gm1·(V_{IN}−V_{REF2})), and the falling slope of the ramp signal V_{RMP} is determined by the second current I₂ (I₂=gm2·V_{REF2}). Therefore, the rising slope of the ramp signal V_{RMP} is influenced by the input voltage V_{IN} and the second reference voltage V_{REF2}, while the falling slope of the ramp signal V_{RMP} is influenced by the second reference voltage V_{REF2}. The function f (V_{IN}, V_{REF2}) used to determine the slope (both rising and falling) of the ramp signal V_{RMP} can be expressed as:

$$f ( {V}_{IN} , {V}_{REF 2} ) = gm 1 \times ( {V}_{IN} - {V}_{REF 2} ) \times D \times T - gm 2 \times {V}_{REF 2} \times ( 1 - D ) \times T$$

From the above, it can be seen that the slope of the ramp signal V_{RMP} is determined by a function that includes the input voltage V_{IN} and the second reference voltage V_{REF2} but does not include the output voltage V_{OUT}.

The factors influencing the slope of the ramp signal V_{RMP} Can also be derived from the process of calculating the output voltage V_{OUT}. Specifically, when the switching power converter circuit 20 operates in Continuous Conduction Mode (i.e., the current through the inductor L does not drop to zero in each switching cycle), assuming that the output voltage V_{OUT} is a fixed DC value, a switching cycle is T, the duty cycle of the switching signal S_D is D, the duty cycle of the switching signal S_DB is (1-D), and the amplitude of the ramp signal V_{RMP} is V_{SW}, based on the capacitor charge balance principle, the following can be derived:

$$gm 1 \times ( {V}_{IN} - {V}_{REF 2} ) \times D \times T - gm 2 \times {V}_{REF 2} \times ( 1 - D ) \times T - \frac{1}{2} \times \frac{1}{R} \times {V}_{SW} \times T - \frac{1}{R} \times ( {V}_{REF 2} - {V}_{OUT} ) \times T = 0 ; \qquad Eq . 1$$

During the period when the switching signal S_D is in an enabled state:

$$C \times {V}_{SW} = gm 1 \times ( {V}_{IN} - {V}_{REF 2} ) \times D \times T - \frac{{V}_{SW}}{2} \times \frac{1}{R} \times D \times T - \frac{1}{R} \times ( {V}_{REF 2} - {V}_{OUT} ) \times D \times T ; \qquad Eq . 2$$

From Eq. 1, it follows:

$${V}_{SW} = 2 \times D \times gm 1 \times ( {V}_{IN} - {V}_{REF 2} ) \times R - 2 \times ( 1 - D ) \times gm 2 \times {V}_{REF 2} \times R - 2 \times ( {V}_{REF 2} - {V}_{OUT} ) ; \qquad Eq . 3$$

From Eq. 2, it follows:

$$( C + \frac{DT}{2 R} ) \times {V}_{SW} = \frac{DT + 2 RC}{2 R} \times {V}_{SW} = D \times gm 1 \times ( {V}_{IN} - {V}_{REF 2} ) \times T - D \times \frac{1}{R} \times ( {V}_{REF2} - {V}_{OUT} ) \times T ; \qquad Eq . 4$$

### Rearranging Eq. 4:

$${V}_{SW} = \frac{2}{DT + 2 RC} \times [ \text{} D \times gm 1 \times ( {V}_{IN} - {V}_{REF 2} ) \times R \times T - D \times ( {V}_{REF 2} - {V}_{OUT} ) \times T ; \qquad Eq . 5$$

From Eq. 3 and Eq. 5, it follows:

$$\frac{1}{DT + 2 RC} \times [ \text{} D \times gm 1 \times ( {V}_{IN} - {V}_{REF 2} ) \times R \times T - D \times ( {V}_{REF 2} - {V}_{OUT} ) \times T = D \times gm 1 \times ( {V}_{IN} - {V}_{REF 2} ) \times R - ( 1 - D ) \times gm 2 \times {V}_{REF 2} \times R - ( {V}_{REF 2} - {V}_{OUT} ) ; \qquad Eq . 6$$

### Rearranging Equation 6:

$${V}_{OUT} = \frac{DT - {D}^{2} T - 2 DRC}{2 RC} \times gm 1 \times ( {V}_{IN} - {V}_{REF 2} ) \times R + \frac{D ( 1 - D ) T + 2 ( 1 - D ) RC}{2 RC} \times gm 2 \times {V}_{REF 2} \times R + {V}_{REF 2} . \qquad Eq . 7$$

Thus, it can be seen that the input voltage V_{IN}, the second reference voltage V_{REF2}, the first transconductance parameter gm1, and the second transconductance parameter gm2 influence the slope of the ramp signal V_{RMP} (e.g., affecting the rising and/or falling slope of the ramp signal V_{RMP}), but the output voltage V_{OUT} does not influence the slope of the ramp signal V_{RMP}. Furthermore, according to Eq. 7, the output voltage V_{OUT} can be adjusted by tuning the second reference voltage V_{REF2}, the first transconductance parameter gm1, or the second transconductance parameter gm2 to achieve the accuracy specifications of the output voltage V_{OUT}.

In such a situation, the switching power converter circuit 20 further includes a calibration circuit 18, which is coupled to the power stage circuit 12 and the ramp signal generator 16 and further configured to determine one or more of the first transconductance parameter gm1, the second transconductance parameter gm2, and the second reference voltage V_{REF2} based on the output voltage V_{OUT} and the second reference voltage V_{REF2}, so that the output voltage V_{OUT} approaches a target voltage to meet accuracy specifications. In other words, the calibration circuit 18 is configured to adjust at least one parameter of the function, which is used to determine the slope of the ramp signal V_{RMP}, based on the output voltage V_{OUT} and the second reference voltage V_{REF2}, so that the output voltage V_{OUT} approaches the target voltage.

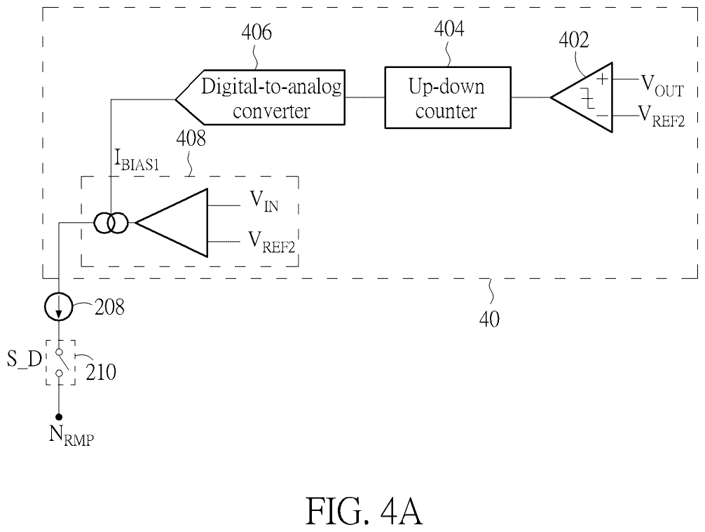

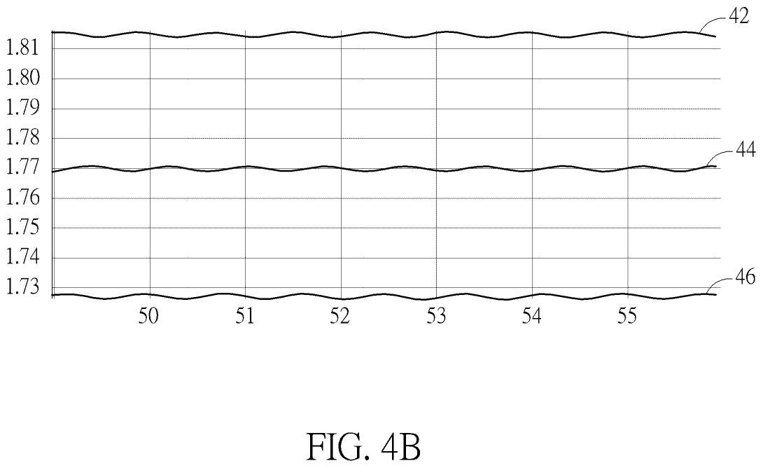

The implementation of the calibration circuit 18 is not limited to a specific architecture, as long as it can determine one or more of the first transconductance parameter gm1, the second transconductance parameter gm2, and the second reference voltage V_{REF2} based on the output voltage V_{OUT} and the second reference voltage V_{REF2}. For example, please refer to FIG. 4A, which is a schematic diagram of a calibration circuit 40 according to an embodiment of the present invention. The calibration circuit 40 is configured to implement the calibration circuit 18 and is used to determine the first transconductance parameter gm1 which is related to the first current I₁ generated by the first current source 208. The calibration circuit 40 includes a comparator circuit 402, an up-down counter 404, a digital-to-analog converter 406, and an operational transconductance amplifier 408. The comparator circuit 402 is configured to compare the output voltage V_{OUT} with the second reference voltage V_{REF2} to generate a comparison result. The up-down counter 404 is coupled to the comparator circuit 402 and is configured to generate a digital count value based on the comparison result of the comparator circuit 402. The digital-to-analog converter 406 is coupled to the up-down counter 404 and is configured to generate an analog signal I_{BIAS1} based on the digital count value of the up-down counter 404, which serves as the bias current for the operational transconductance amplifier 408. The operational transconductance amplifier 408 is coupled to the digital-to-analog converter 406 and the first current source 208 of the ramp signal generator 16 and is configured to generate an output current based on a voltage difference between the input voltage V_{IN} and the second reference voltage V_{REF2}, and further to provide the output current to the first current source 208 as the first current I₁. Additionally, the operational transconductance amplifier 408 determines a conversion ratio of the voltage difference to the output current based on the analog signal IBIAS, which serves as the first transconductance parameter gm1.

During the operation of the calibration circuit 40, the comparator circuit 402 first compares the magnitude of the output voltage V_{OUT} with the second reference voltage V_{REF2}. If the output voltage V_{OUT} is greater than the second reference voltage V_{REF2}, the comparator circuit 402 outputs a high-level comparison result; conversely, if the output voltage V_{OUT} is less than the second reference voltage V_{REF2}, the comparator circuit 402 outputs a low-level comparison result. The up-down counter 404 performs counting based on this comparison result, increments the count value when the comparison result is high-level and decrements the count value when the comparison result is low-level. The digital-to-analog converter 406 generates the corresponding analog signal I_{BIAS1} based on the digital count value, and in this example, the analog signal I_{BIAS1} is in the form of a current. Finally, the operational transconductance amplifier 408 determines the conversion ratio of the voltage difference between the input voltage V_{IN} and the second reference voltage V_{REF2} to the output current based on the analog signal I_{BIAS1}. Specifically, the primary function of the operational transconductance amplifier 408 is to convert an input voltage difference into an output current. In this embodiment, the operational transconductance amplifier 408 receives the input voltage V_{IN} and the second reference voltage V_{REF2} as differential inputs and converts this voltage difference into an output current, with the conversion ratio (i.e., the first transconductance parameter gm1) determined by the analog signal I_{BIAS1}. When the analog signal I_{BIAS1} increases, the first transconductance parameter gm1 increases accordingly, allowing a larger output current to be generated for the same input voltage difference; conversely, when the analog signal I_{BIAS1} decreases, the first transconductance parameter gm1 decreases accordingly, allowing a smaller output current to be generated for the same input voltage difference. By adjusting the first transconductance parameter gm1, the magnitude of the first current I₁ generated by the first current source 208 is altered, which ultimately affects the characteristics of the ramp signal V_{RMP} (e.g., the rising slope of the ramp signal V_{RMP}), and enables the output voltage V_{OUT} to gradually approach the target voltage value. Through this feedback adjustment mechanism, the output voltage V_{OUT} can gradually approach the target voltage value.

For example, please refer to FIG. 4B, which is a schematic diagram illustrating that the calibration circuit 40 of FIG. 4A adjusts the first transconductance parameter gm1 to change the output voltage V_{OUT}. In FIG. 4B, a curve 42 indicates that when the calibration circuit 40 adjusts the first transconductance parameter gm1 to 0.5ρ, the output voltage V_{OUT} is 1.8149 volts; a curve 44 indicates that when the calibration circuit 40 adjusts the first transconductance parameter gm1 to 1μ, the output voltage V_{OUT} is 1.7699 volts; a curve 46 indicates that when the calibration circuit 40 adjusts the first transconductance parameter gm1 to 1.5μ, the output voltage V_{OUT} is 1.7272 volts. Thus, FIG. 4B demonstrates that by adjusting the first transconductance parameter gm1, the characteristics of the ramp signal V_{RMP} can be influenced, such that the output voltage V_{OUT} can approach the target voltage value.

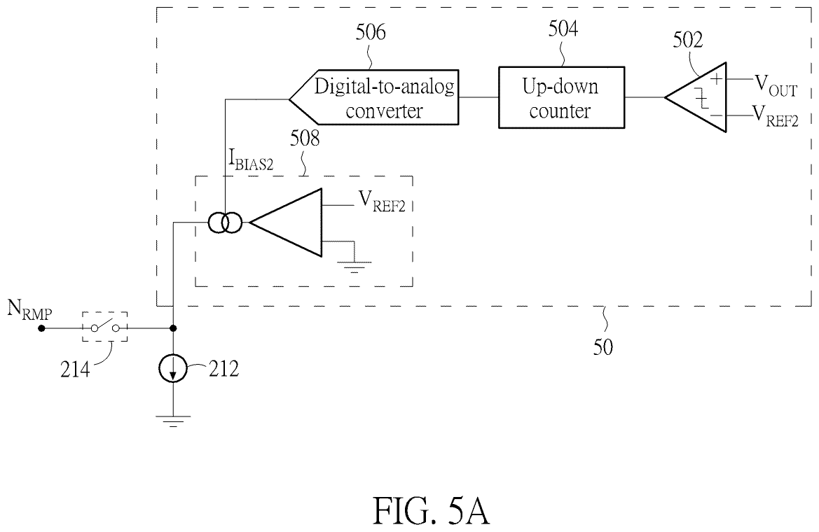

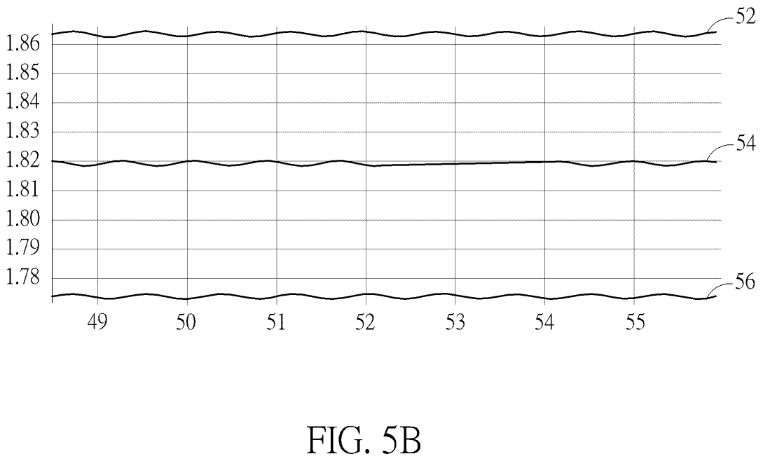

Please refer to FIG. 5A, which is a schematic diagram of a calibration circuit 50 according to an embodiment of the present invention. The calibration circuit 50 is configured to implement the calibration circuit 18 and is used to determine the second transconductance parameter gm2 which is related to the second current I₂ generated by the second current source 212. The calibration circuit 50 includes a comparator circuit 502, an up-down counter 504, a digital-to-analog converter 506, and an operational transconductance amplifier 508. The comparator circuit 502 is configured to compare the output voltage V_{OUT} with the second reference voltage V_{REF2} to generate a comparison result. The up-down counter 504 is coupled to the comparator circuit 502 and is configured to generate a digital count value based on the comparison result of the comparator circuit 502. The digital-to-analog converter 506 is coupled to the up-down counter 504 and is configured to generate an analog signal I_{BIAS2} based on the digital count value of the up-down counter 504, which serves as the bias current for the operational transconductance amplifier 508. The operational transconductance amplifier 508 is coupled to the digital-to-analog converter 506, the second current source 212, and the second switch 214 and is configured to generate an output current based on a voltage difference between the second reference voltage V_{REF2} and a ground voltage, and further to provide the output current to the second current source 212 as the second current I₂. Additionally, the operational transconductance amplifier 508 determines a conversion ratio of the voltage difference to the output current based on the analog signal I_{BIAS2}, Which serves as the second transconductance parameter gm2.

The operation and principles of the calibration circuit 50 are similar to those of the calibration circuit 40 and can be appropriately inferred from the foregoing description, and thus are not repeated here.

Therefore, the calibration circuit 50 can adjust the characteristics of the second current source 212 (e.g., the falling slope of the ramp signal V_{RMP}), thereby adjusting the characteristics of the ramp signal V_{RMP}, to enable the output voltage V_{OUT} to approach the target voltage. For example, please refer to FIG. 5B, which is a schematic diagram illustrating that the calibration circuit 50 of FIG. 5A adjusts the second transconductance parameter gm2 to change the output voltage V_{OUT}. In FIG. 5B, a curve 52 indicates that when the calibration circuit 50 adjusts the second transconductance parameter gm2 to 1.5μ, the output voltage V_{OUT} is 1.8637 volts; a curve 54 indicates that when the calibration circuit 50 adjusts the second transconductance parameter gm2 to 1μ, the output voltage V_{OUT} is 1.8193 volts; a curve 56 indicates that when the calibration circuit 50 adjusts the second transconductance parameter gm2 to 0.5μ, the output voltage V_{OUT} is 1.7739 volts. Thus, FIG. 5B demonstrates that by adjusting the second transconductance parameter gm2, the characteristics of the ramp signal V_{RMP} can be influenced, such that the output voltage V_{OUT} can approach the target voltage value.

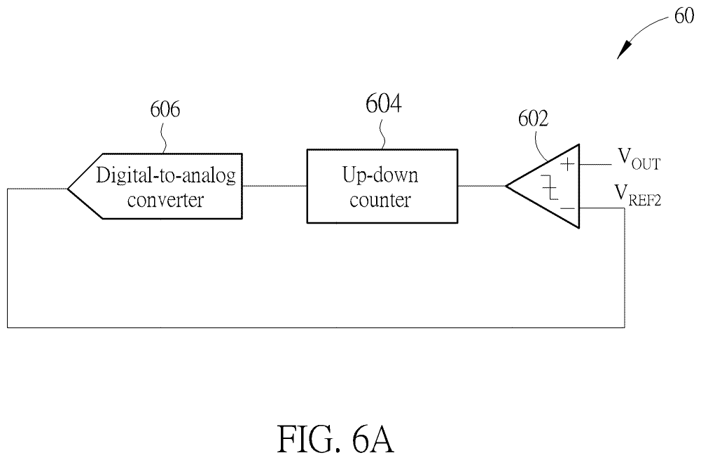

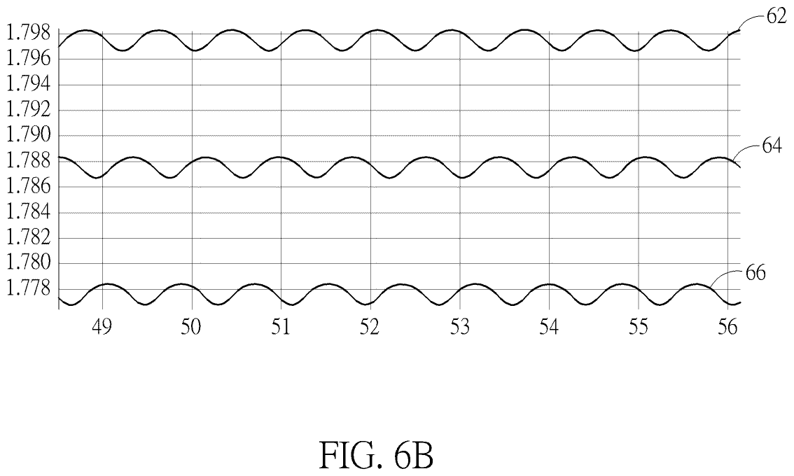

Please refer to FIG. 6A, which is a schematic diagram of a calibration circuit 60 according to an embodiment of the present invention. In this embodiment, the calibration circuit 60 is configured to implement the calibration circuit 18 and is used to determine the second reference voltage V_{REF2} Which is related to the reference voltage for the first current source 208 and the second current source 212, which serves as a parameter for determining the first current I₁ generated by the first current source 208 and the second current I₂ generated by the second current source 212. Specifically, the calibration circuit 60 is a feedback circuit that includes a comparator circuit 602, an up-down counter 604, and a digital-to-analog converter 606. The comparator circuit 602 is configured to compare the output voltage V_{OUT} with the second reference voltage V_{REF2} to generate a comparison result. The up-down counter 604 is coupled to the comparator circuit 602 and is configured to generate a digital count value based on the comparison result of the comparator circuit 602. The digital-to-analog converter 606 is coupled to the up-down counter 604 and is configured to generate the second reference voltage V_{REF2} based on the digital count value of the up-down counter 604 and to output it back to the comparator circuit 602.

During operation, the calibration circuit 60 forms a complete feedback loop. First, the comparator circuit 602 compares the magnitude of the output voltage V_{OUT} with the second reference voltage V_{REF2}. If the output voltage V_{OUT} is greater than the second reference voltage V_{REF2}, the comparator circuit 602 outputs a high-level comparison result; conversely, if the output voltage V_{OUT} is less than the second reference voltage V_{REF2}, the comparator circuit 602 outputs a low-level comparison result. The up-down counter 604 adjusts its count value based on this comparison result, increments the count value when the comparison result is high-level, indicating a need to increase the second reference voltage V_{REF2}, and decrements the count value when the comparison result is low-level, indicating a need to decrease the second reference voltage V_{REF2}. The digital-to-analog converter 606 converts this digital count value into a new second reference voltage V_{REF2} and feeds it back to the comparator circuit 602, to initiate a new round of comparison. In this architecture, the digital-to-analog converter 606 may employ a resistor-network-based digital-to-analog converter, such as a ladder network composed of single and double resistor values or a series of equal-value resistors forming a voltage divider, but it is not limited to this.

Since the second reference voltage V_{REF2} serves as the reference voltage for both the first current source 208 and the second current source 212, changes in its value simultaneously affect the magnitudes of these two currents, thereby altering the characteristics of the ramp signal V_{RMP}. Through this feedback adjustment mechanism, the system can adjust the value of the second reference voltage V_{REF2}, and enable the output voltage V_{OUT} to reach the desired target voltage value.

Therefore, the calibration circuit 60 can adjust the reference voltage of the first current source 208 and the second current source 212, thereby adjusting the characteristics of the ramp signal V_{RMP}, so as to enable the output voltage V_{OUT} to approach the target voltage. For example, please refer to FIG. 6B, which is a schematic diagram illustrating that the calibration circuit 60 of FIG. 6A adjusts the second reference voltage V_{REF2} to change the output voltage V_{OUT}. In FIG. 6B, a curve 62 indicates that when the calibration circuit 60 adjusts the second reference voltage V_{REF2} to 1.81 volts, the output voltage V_{OUT} is 1.7976 volts; a curve 64 indicates that when the calibration circuit 60 adjusts the second reference voltage V_{REF2} to 1.8 volts, the output voltage V_{OUT} is 1.7876 volts; a curve 66 indicates that when the calibration circuit 60 adjusts the second reference voltage V_{REF2} to 1.79 volts, the output voltage V_{OUT} is 1.7777 volts. Thus, FIG. 6B demonstrates that by adjusting the second reference voltage V_{REF2}, the characteristics of the ramp signal V_{RMP} can be influenced, to enable the output voltage V_{OUT} to approach the target voltage value.

It should be noted that the calibration circuits 40, 50, and 60 can all achieve the purpose of adjusting the characteristics of the ramp signal V_{RMP}, and enabling the output voltage V_{OUT} to approach the target voltage. In practical applications, one of these implementations may be selected based on circuit design requirements, or multiple implementations may be combined, and an appropriate circuit architecture may be chosen. Furthermore, the calibration circuits 40, 50, and 60 are configured to implement the calibration circuit 18, and their operation timing can be flexibly configured based on system requirements to further enhance the performance and efficiency of the switching power converter circuit 10 or 20. For example, in one embodiment, the calibration circuits 18, 40, 50, and 60 may operate during system power-on, dynamically adjusting the first transconductance parameter gm1, the second transconductance parameter gm2, or the second reference voltage V_{REF2} through an initial calibration process to ensure that the output voltage V_{OUT} quickly approaches the target voltage while compensating for manufacturing variations or environmental conditions. Additionally, the calibration circuits 18, 40, 50, and 60 may also operate periodically after power-on, such as at regular intervals or when significant changes in the load or the input voltage V_{IN} are detected, which maintains the stability and accuracy of the output voltage V_{OUT} through periodic calibration.

According to one embodiment, the switching power converter circuit 10 or 20 may not include the calibration circuit 18. In this embodiment, each of the second reference voltage V_{REF2}, the first transconductance parameter gm1, and the second transconductance parameter gm2 may be preset to a fixed value based on the target voltage of the output voltage V_{OUT}, or the second reference voltage V_{REF2}, the first transconductance parameter gm1, and the second transconductance parameter gm2 may be preset in respective ranges based on the target voltage of the output voltage V_{OUT}. During the operation of the switching power converter circuit 10 or 20, each of the second reference voltage V_{REF2}, the first transconductance parameter gm1, and the second transconductance parameter gm2 is set to a value within its corresponding preset range based on manufacturing variations or environmental conditions.

Overall, the switching power converter circuit 10 in FIG. 1 or the switching power converter circuit 20 in FIG. 2 generates the ramp signal V_{RMP} through the ramp signal generator 16, with its slope which is determined by the input voltage V_{IN} and the second reference voltage V_{REF2} and unaffected by the output voltage V_{OUT}, thereby enhancing system stability and optimizing load transient response performance. In this architecture, the switching power converter circuits 10 and 20 do not require an error amplifier, to avoid delays caused by compensation circuits and achieve faster response speeds. Additionally, the switching power converter circuits 10 and 20 may be appropriately configured with a calibration circuit to dynamically adjust the first transconductance parameter gm1, the second transconductance parameter gm2, or the second reference voltage V_{REF2}, so as to ensure that the output voltage V_{OUT} accurately approaches the target voltage, and further to enhance the closed-loop stability and accuracy of the output voltage V_{OUT}.

Furthermore, the switching power converter circuits 10 and 20 of the present invention and their calibration mechanisms are applicable to various applications, such as mobile devices, Internet of Things (IoT) devices, server power management, and industrial control systems. Particularly in low-power applications, the design of the present invention without an error amplifier avoids delays caused by compensation circuits, improving system efficiency and response speed, while the dynamic adjustment of the calibration circuit ensures the stability of the output voltage, to meet high-reliability requirements.

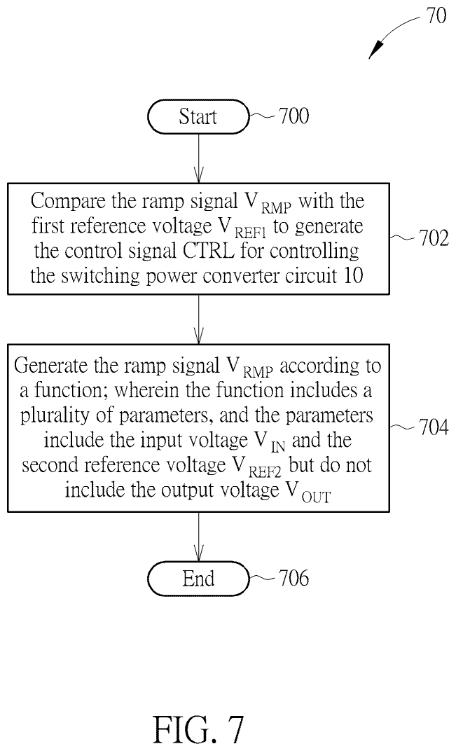

The operation of the switching power converter circuits 10 and 20 can be summarized as a control process 70, as shown in FIG. 7. The control process 70 can be applied to the switching power converter circuit 10 or 20 and includes the following steps:

Step 700: Start.

Step 702: Compare the ramp signal V_{RMP} with the first reference voltage V_{REF1} to generate the control signal CTRL for controlling the switching power converter circuit 10.

Step 704: Generate the ramp signal V_{RMP} according to a function; wherein the function includes a plurality of parameters, and the parameters include the input voltage V_{IN} and the second reference voltage V_{REF2} but do not include the output voltage V_{OUT}.

Step 706: End.

The detailed operation or variations of the control process 70 can be referred to the foregoing description and are not repeated here.

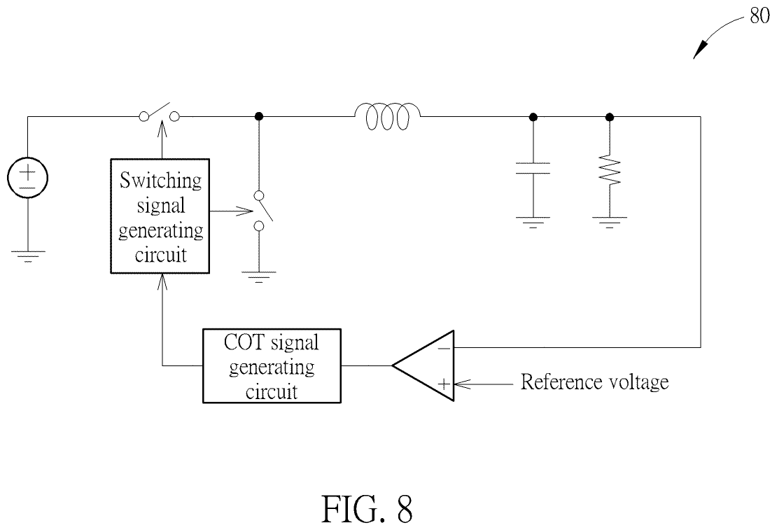

In the prior art, switching power converters with a COT control architecture lack an appropriate frequency compensation mechanism, resulting in poor closed-loop stability and affecting reliability. For example, please refer to FIG. 8, which is a schematic diagram of a conventional switching power converter 80. The switching power converter 80 adopts a COT control architecture, wherein its control circuit directly compares the output voltage with a reference voltage to generate a control signal. The advantage of this architecture is its extremely fast load transient response performance, as changes in the output voltage can be directly and rapidly reflected in the control signal. However, due to the lack of an appropriate frequency compensation mechanism, the switching power converter 80 has poor closed-loop stability, and the accuracy of the output voltage is also affected. Such instability may cause the system to oscillate under certain operating conditions and affect the reliability of the switching power converter 80. In contrast, the switching power converter circuit 10 or 20 of the embodiments of the present invention generates the ramp signal V_{RMP} through the ramp signal generator 16, with its slope determined by the input voltage V_{IN} and the second reference voltage V_{REF2}, unaffected by the output voltage V_{OUT}, thereby enhancing system stability and optimizing load transient response performance.

The prior art also provides an improved architecture that introduces a ramp signal generation circuit based on a function of the input voltage and the output voltage on the basis of the switching power converter 80 to increase the system's noise margin. This design improves closed-loop stability, and the accuracy of the output voltage is also enhanced. However, this improvement comes at the cost of increased circuit complexity, and requires an error amplifier to be added before the ramp signal generation circuit, where the error amplifier requires additional compensation circuits to ensure system stability. These additional circuits inevitably increase signal transmission delays. When the output voltage experiences a load transient change, the signal needs to be processed by the error amplifier and then transmitted through the ramp circuit before it can be reflected in the control signal, resulting in slower load transient response speed. In contrast, the switching power converter circuits 10 and 20 of the embodiments of the present invention do not require an error amplifier, avoiding delays caused by compensation circuits and achieving faster response speeds.

In summary, the switching power converter circuit of the present invention generates a ramp signal through a ramp signal generator, with its slope unaffected by the output voltage, so as to enhance system stability and optimize load transient response performance. Moreover, the switching power converter circuit of the present invention does not require an error amplifier, which avoids delays caused by compensation circuits and achieves faster response speeds.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A switching power converter circuit, comprising:
a power stage circuit, configured to generate an output voltage based on an input voltage;
a control circuit, configured to compare a ramp signal with a first reference voltage to generate a control signal for controlling the power stage circuit; and
a ramp signal generator, coupled to the control circuit, configured to generate the ramp signal and determine a slope of the ramp signal according to a function;
wherein the function includes a plurality of parameters, and the plurality of parameters include the input voltage and a second reference voltage but do not include the output voltage.

2. The switching power converter circuit of claim 1, wherein the ramp signal generator comprises:
a resistor-capacitor circuit, coupled between the control circuit and the output voltage or between the control circuit and a ground terminal;
a first current source, configured to generate a first current, the first current being related to the input voltage, the second reference voltage, and a first transconductance parameter;
a first switch, including a first terminal coupled to the first current source and a second terminal coupled to the control circuit, configured to switch a conduction state from the first terminal to the second terminal based on the control signal;
a second current source, configured to generate a second current, the second current being related to the second reference voltage and a second transconductance parameter; and
a second switch, including a first terminal coupled to the second current source and a second terminal coupled to the control circuit, configured to switch a conduction state from the first terminal to the second terminal based on the control signal;
wherein the parameters of the function further include the first transconductance parameter and the second transconductance parameter.

3. The switching power converter circuit of claim 2, wherein the resistor-capacitor circuit further comprises a switching switch configured to switch a connection to the output voltage or the ground terminal.

4. The switching power converter circuit of claim 2, further comprising:
a calibration circuit, coupled to the power stage circuit and the ramp signal generator, configured to determine one or more of the first transconductance parameter, the second transconductance parameter, and the second reference voltage based on the output voltage and the second reference voltage, so that the output voltage approaches a target voltage.

5. The switching power converter circuit of claim 4, wherein the calibration circuit comprises:
a comparator circuit, configured to compare the output voltage with the second reference voltage to generate a comparison result;
an up-down counter, coupled to the comparator circuit, configured to generate a digital count value based on the comparison result;
a digital-to-analog converter, coupled to the up-down counter, configured to generate an analog signal based on the digital count value; and
an operational transconductance amplifier, coupled to the digital-to-analog converter and the ramp signal generator, configured to generate an output current based on a voltage difference between the input voltage and the second reference voltage, and further to determine a conversion ratio of the voltage difference to the output current based on the analog signal, serving as the first transconductance parameter.

6. The switching power converter circuit of claim 4, wherein the calibration circuit comprises:
a comparator circuit, configured to compare the output voltage with the second reference voltage to generate a comparison result;
an up-down counter, coupled to the comparator circuit, configured to generate a digital count value based on the comparison result;
a digital-to-analog converter, coupled to the up-down counter, configured to generate an analog signal based on the digital count value; and
an operational transconductance amplifier, coupled to the digital-to-analog converter and the ramp signal generator, configured to generate an output current based on a voltage difference between the second reference voltage and a ground voltage, and further to determine a conversion ratio of the voltage difference to the output current based on the analog signal, serving as the second transconductance parameter.

7. The switching power converter circuit of claim 4, wherein the calibration circuit comprises:
a comparator circuit, configured to compare the output voltage with the second reference voltage to generate a comparison result;
an up-down counter, coupled to the comparator circuit, configured to generate a digital count value based on the comparison result; and
a digital-to-analog converter, coupled to the up-down counter, configured to generate the second reference voltage based on the digital count value and to output it to the comparator circuit.

8. The switching power converter circuit of claim 1, wherein the power stage circuit comprises:
a high-side switch, coupled between the input voltage and a switching node;
a low-side switch, coupled between the switching node and a ground terminal; and
an inductor, coupled between the switching node and the output voltage.

9. The switching power converter circuit of claim 1, wherein the switching power converter circuit does not generate the ramp signal through an error amplifier.

10. The switching power converter circuit of claim 1, wherein the first reference voltage has a temperature-independent fixed voltage value.

11. The switching power converter circuit of claim 1, further comprising:
a calibration circuit, coupled to the power stage circuit and the ramp signal generator, configured to adjust at least one of the parameters of the function based on the output voltage and the second reference voltage, so that the output voltage approaches a target voltage.

12. A control method for a switching power converter circuit, the switching power converter circuit being configured to generate an output voltage based on an input voltage, the control method comprising:
comparing a ramp signal with a first reference voltage to generate a control signal for controlling the switching power converter circuit; and
generating the ramp signal according to a function;
wherein the function includes a plurality of parameters, and the plurality of parameters include the input voltage and a second reference voltage but do not include the output voltage.

13. The control method of claim 12, wherein the step of generating the ramp signal according to the function comprises:
generating a first current, the first current being related to the input voltage, the second reference voltage, and a first transconductance parameter;
generating a second current, the second current being related to the second reference voltage and a second transconductance parameter; and
controlling charging and discharging of a resistor-capacitor circuit by the first current and the second current based on the control signal to generate the ramp signal;
wherein the parameters of the function further include the first transconductance parameter and the second transconductance parameter.

14. The control method of claim 13, further comprising:
determining one or more of the first transconductance parameter, the second transconductance parameter, and the second reference voltage based on the output voltage and the second reference voltage, so that the output voltage approaches a target voltage.

15. The control method of claim 14, wherein determining one or more of the first transconductance parameter, the second transconductance parameter, and the second reference voltage based on the output voltage and the second reference voltage comprises:
comparing the output voltage with the second reference voltage to generate a comparison result;
generating a digital count value based on the comparison result;
generating an analog signal based on the digital count value; and
generating an output current based on a voltage difference between the input voltage and the second reference voltage, and determining a conversion ratio of the voltage difference to the output current based on the analog signal, serving as the first transconductance parameter.

16. The control method of claim 14, wherein determining one or more of the first transconductance parameter, the second transconductance parameter, and the second reference voltage based on the output voltage and the second reference voltage comprises:
comparing the output voltage with the second reference voltage to generate a comparison result;
generating a digital count value based on the comparison result;
generating an analog signal based on the digital count value; and
generating an output current based on a voltage difference between the second reference voltage and a ground voltage, and determining a conversion ratio of the voltage difference to the output current based on the analog signal, serving as the second transconductance parameter.

17. The control method of claim 14, wherein the step of adjusting the at least one parameter of the function based on the output voltage and the second reference voltage comprises:
comparing the output voltage with the second reference voltage to generate a comparison result;
generating a digital count value based on the comparison result; and
generating the second reference voltage based on the digital count value.

18. The control method of claim 13, further comprising:
switching a connection of the resistor-capacitor circuit to the output voltage or a ground terminal.

19. The control method of claim 12, wherein the first reference voltage has a temperature-independent fixed voltage value.

20. The control method of claim 12, further comprising:
adjusting at least one of the parameters of the function based on the output voltage and the second reference voltage, so that the output voltage approaches a target voltage.
